(19) United States
(12) Patent Application Publication
(10) Pub. No.: US 2015/0074944 A1
(43) Pub. Date: Mar. 19, 2015

(54) COVERED HINGE ASSEMBLY

(71) Applicant: Marine Town Inc., New Taipei City (TW)

(72) Inventor: Chin-Chung TUNG, New Taipei City (TW)

(21) Appl. No.: 14/027,739

(22) Filed: Sep. 16, 2013

(51) Int. Cl. E05D 11/00; E05D 3/02

(52) U.S. Cl. CPC E05D 11/0054; E05D 3/02
USPC 16/251

(57) ABSTRACT

A covered hinge assembly includes a pivotal pin, at least one hinge leaf, and at least one hinge cover. The hinge cover has a plate covering the hinge leaf and a connecting portion rotatably combining with the pivotal pin so as to pivot, together with the plate, on the pivotal pin. The covered hinge assembly is safe and convenient in use and economical in maintenance, making it perfect for marine applications.

### BACKGROUND OF THE INVENTION

1. Technical Field The present invention relates hinges, and more particularly, to a covered hinge assembly that has at least one removably attached cover for protective and esthetic purposes.

2. Description of Related Art

Hinges have been extensively used as reliable hardware for holding and allowing operation of movable assemblies, like hatches, doors and casements. A conventional hinge is typically fixed to a wall, a plate or a board by fasteners like rivets or screws with the head of such rivets or screws left exposed. The exposed part of the rivet or screw, however, can degrade the appearance of the article using the hinge, and make the rivet or screw subject to rustiness or looseness. For improving the conventional hinge, many designs have been proposed in which one of the most effective solutions is the inventor's previous invention titled “Boat Hinge Cover” patented as U.S. Pat. No. 6,721,992. This patented approach implements a plate adhered to the hinge's leaf through an adhesive, thereby hiding the hinge's fasteners from view and unexpected impacts. While this patented approach relying on an adhesive or a two-way tape does fix the cover plate to the hinge leaf, it nevertheless leaves some needs unmet and may require further improvement. First, the adhesive combination between the cover plate and the hinge leaf is for one-time use only. Once the cover plate is forcedly detached from the hinge leaf when the hinge assembly needs repair or maintenance, the combination and, at least, the adhesive (two-way tape) is unavoidably destroyed. In an even worse case, the cover plate may be deformed or bent under an excessive pulling force and become unusable. Another problem of such a prior-art device is that the completely detached cover plate can be lost during the repair or maintenance of the hinge assembly even if it is not deformed. This risk causes a user has to prepare a lot of spares and renders this approach uneconomic. At last, there is possibility that the tape only sticks to the screw heads but not the hinge leaf itself. In this case, the cover plate can be easily removed by pressurized water column during washing or when hit otherwise. Even if the cover plate survives external impacts, it tends to be deformed under repeated stepping when installed on a boat deck or otherwise pressing.

Hence, there is a need for an improved hinge that address all the inconvenience, waste and unsafety existing in the prior art.

### SUMMARY OF THE INVENTION

In view of the need as described above, one objective of the present invention is to provide a covered hinge assembly, which has a cover that is pivotable with respect to and removably engaged with a hinge leaf thereof and can be repeatedly used.

Another objective of the present invention is to provide a covered hinge assembly, which has a cover that is assembled with a hinge pivot thereof and thus is totally free from loss.

Still another objective of the present invention is to provide a covered hinge assembly, which has a cover that can reliably conceal fasteners on a hinge leaf thereof from pressurized water column and external impacts, such as human kicks, so as to prevent the fasteners from rustiness or looseness.

Yet another objective of the present invention is to provide a covered hinge assembly, which presents an integrated, esthetic appearance, making a high-end product using it look more valuable.

For achieving the above and other objectives, a covered hinge assembly according to the present invention comprises: a pivotal pin; at least one hinge leaf, extending between a proximal end adjacent the pivotal pin and a distal end, the hinge leaf extending between opposite first and second edges, the hinge leaf having at least one fastener penetrating therethrough, the fastener having a head; and at least one hinge cover, including: a plate extending between opposite first and second ends, the plate extending between opposite first and second edges, the plate having opposite upper and lower surfaces, the plate covering the hinge leaf and the fastener head; and a connecting portion being provided at the first end of the plate, the connecting portion rotatably combining with the pivotal pin so as to pivot, together with the plate, on the pivotal pin.

Also provided is a covered hinge assembly as described further having the first end of the plate of the hinge cover juxtaposed with the proximal end of the hinge leaf, and the second end of the plate of the hinge cover juxtaposed with the distal end of the hinge leaf.

Also provided is a covered hinge assembly as described further having the first and second edges of the plate of the hinge cover juxtaposed with the first and second edges of the hinge leaf, respectively.

Also provided is a covered hinge assembly as described further having the hinge leaf provided with at least one raised portion such that when the hinge cover covers the hinge leaf, a top surface of the raised portion fittingly contacts the lower surface of the plate of the hinge cover and thereby props up the plate from below.

Also provided is a covered hinge assembly as described further having the connecting portion being at least one ring or hook integratedly formed at the first end of the plate to be mounted around the pivotal pin.

Also provided is a covered hinge assembly as described further having the hinge cover constructed of stainless steel.

Also provided is a covered hinge assembly as described further having the hinge cover molded from plastic.

Also provided is a covered hinge assembly as described further having the plate of the hinge cover provided with a skirt extending along the first and second edges and the second end of the plate, the skirt projecting outward from the lower surface of the plate, so as to cover the first and second edges and the distal end of the hinge leaf.

Also provided is a covered hinge assembly as described further having a first fastening member provided at the distal end of the hinge leaf and a second fastening member provided on the skirt corresponding to the second end of the plate, such that when the hinge cover covers the hinge leaf, the first and second fastening members engage with each other and hold the hinge cover and the hinge leaf together.

Also provided is a covered hinge assembly as described further having a first fastening member provided at the distal end of the hinge leaf and a second fastening member provided on the second end of the plate, such that when the hinge cover covers the hinge leaf, the first and second fastening members engage with each other and hold the hinge cover and the hinge leaf together.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a covered hinge according to one preferred embodiment of the present invention;

FIG. 2 is an exploded view of the covered hinge of FIG. 1;

FIG. 3 is a top view of a cover used in the covered hinge of FIG. 1;

FIG. 4 is a side view of the cover used in the covered hinge of FIG. 1;

FIG. 5 is a bottom view of the cover used in the covered hinge of FIG. 1;

FIG. 6 is a cross-sectional view of the covered hinge taken along Line 6-6 of FIG. 1;

FIG. 7 is another cross-sectional view of the covered hinge taken along Line 7-7 of FIG. 1; and

FIG. 8 is an applied view of the covered hinge of FIG. 1.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiment, people would further understand the technical means and effects the present invention adopts to achieve the above-indicated objectives. However, the accompanying drawings are intended for reference and illustration, but not to limit the present invention and are not made to scale.

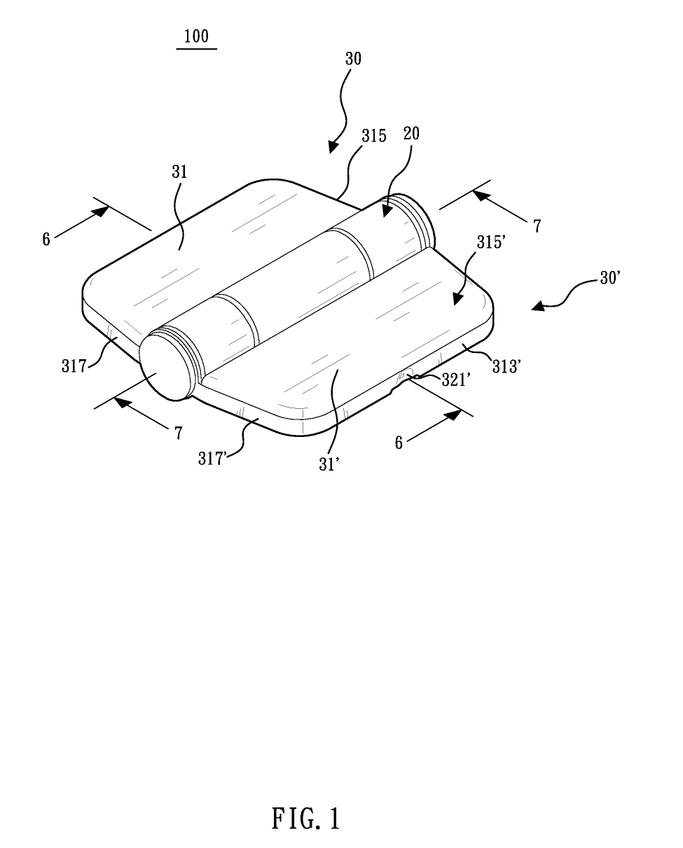

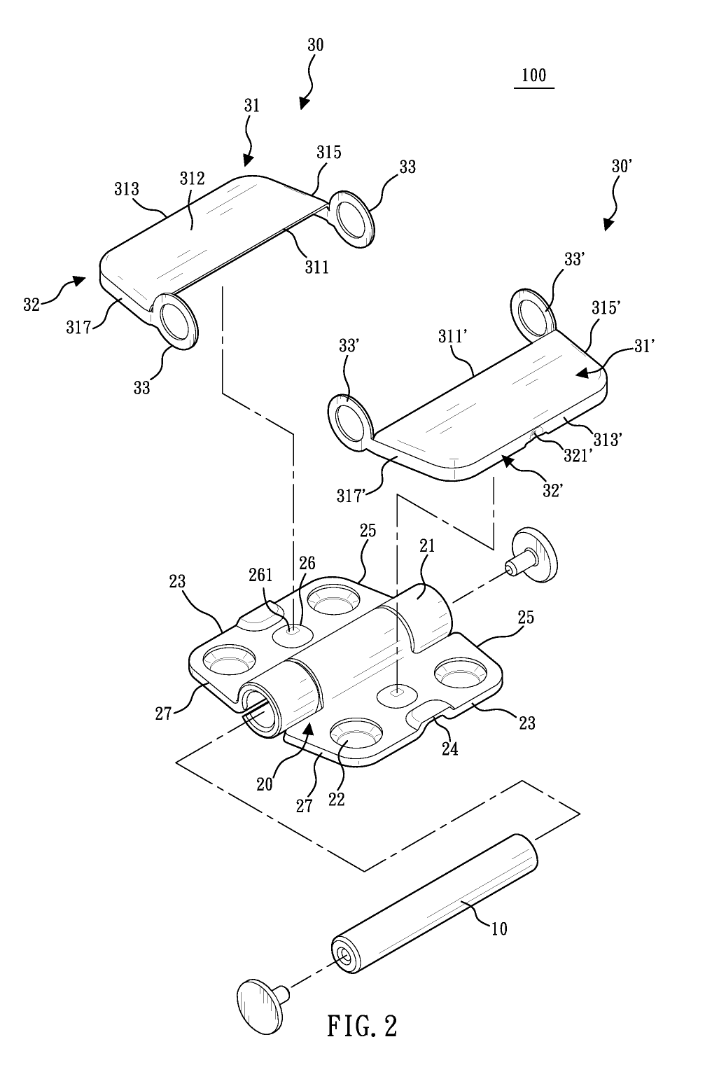

Please refer to FIGS. 1 and 2, according to one preferred embodiment of the present invention, a covered hinge assembly 100 comprises a pivotal pin 10, two hinge leaves 20 pivotally connected to the pivotal pin 10, and two hinge covers 30, 30′ corresponding to the two hinge leaves 20.

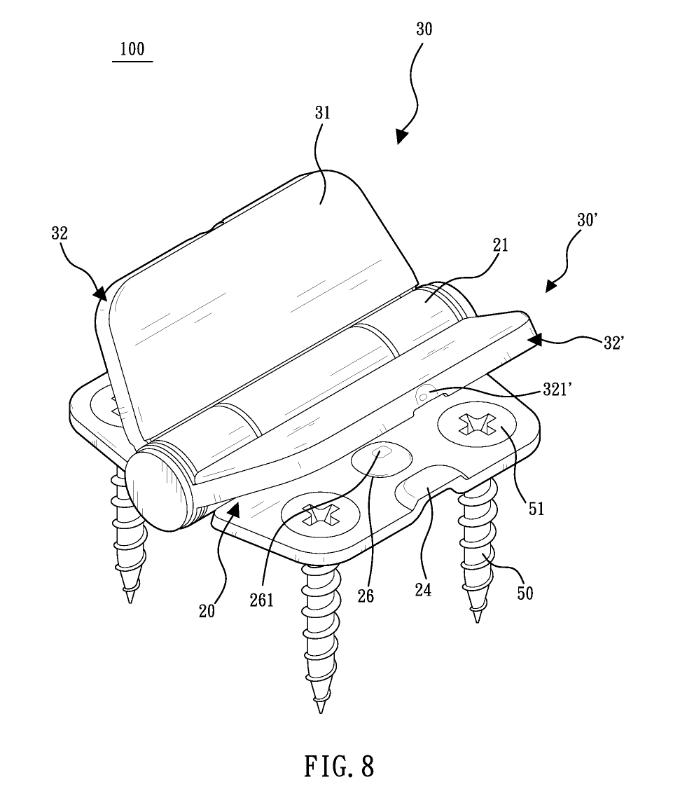

Each said hinge leaf 20 extends between a proximal end 21 adjacent to the pivotal pin 10 and a distal end 23. The hinge leaf 20 also extends between opposite first and second edges 25, 27. The hinge leaf 20 has plural fastening holes 22 for receiving fasteners penetrating through the hinge leaf 20. As shown in FIG. 8, each of such fasteners 50 has a head 51.

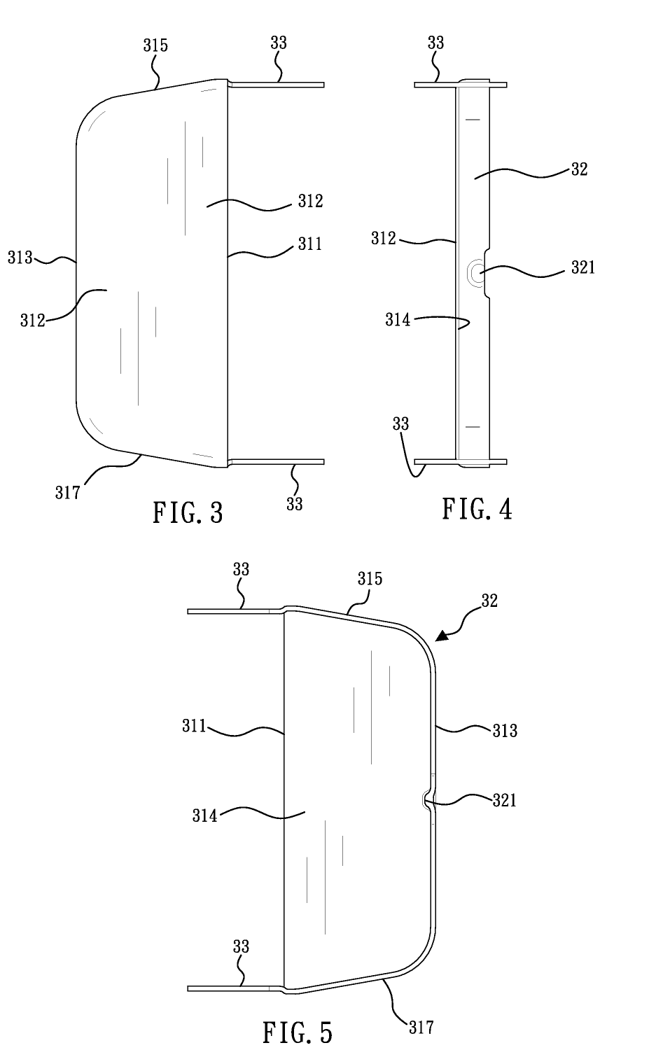

Referring to FIGS. 1-5, the hinge cover 30, 30′ primarily includes a plate 31, 31′ and two connecting portions 33, 33′ integratedly formed with the plate 31, 31′. The hinge cover 30, 30′ may be made from stainless steel through a stamping process, or made from plastic through a molding process.

The plate 31, 31′ extends between opposite first and second ends 311, 311′, 313, 313′. The plate 31, 31′ also extends between opposite first and second edges 315, 315′, 317, 317′. The plate 31, 31′ has opposite upper and lower surfaces 312, 312′, 314, 314′. The plate 31, 31′ covers the corresponding hinge leaf 20 and the fastener heads 51.

The connecting portion 33, 33′ is provided at the first end 311, 311′ of the plate 31, 31′. The connecting portion 33, 33′ rotatably combines with the pivotal pin 10 so as to pivot, together with the plate 31, 31′, on the pivotal pin 10. As shown, the connecting portion 33, 33′ herein is a ring integratedly formed at the first end 311, 311′ of the plate 31, 31′ and has a configuration allowing it to be mounted around the pivotal pin 10, as shown in FIG. 7. However, the connecting portion 33, 33′ may be formed as a hook (not shown), as long as it can stably attach to the pivotal pin 10 and carry the plate 31, 31′ to pivot on the pivotal pin 10.

Since the hinge cover 30, 30′ is connected to the pivotal pin 10 through the connecting portion 33, 33′ even when it is lifted from the hinge leaf 20, the hinge cover 30, 30′ is totally free from loss, thereby eliminating the need of preparing spares.

With the above-described pivotal mechanism, the hinge cover 30, 30′ can repeatedly cover and uncover the hinge leaf 20 without the risk of getting damaged or lost, thus being economical.

In the depicted embodiment, the first end 311, 311′ of the plate 31, 31′ of the hinge cover 30, 30′ is juxtaposed with the proximal end 21 of the hinge leaf 20, and the second end 313 of the plate 31, 31′ of the hinge cover 30, 30′ is juxtaposed with the distal end 23 of the hinge leaf 20. Furthermore, the first and second edges 315, 315′, 317, 317′ of the plate 31, 31′ of the hinge cover 30, 30′ are juxtaposed with the first and second edges 25, 27 of the hinge leaf 20, respectively. Thereby, the hinge leaf 20 is completely concealed by the hinge cover 30, 30′, making the overall hinge assemble sightlier and secure to its user. In terms of appearance, its integrated, esthetic appearance makes a high-end product using it look more valuable. When talking about the structural strength, the hinge cover 30, 30′ can reliably conceal the fasteners 50 on the hinge leaf 20 thereof from pressurized water column and external impacts, such as human kicks, so as to reduce the chance of the fasteners 50 being rusted or loose.

As shown, the plate 31, 31′ of the hinge cover 30, 30′ has a skirt 32, 32′ extending along the first and second edges 315, 315′, 317, 317′ and the second end 313, 313′ of the plate 31, 31′. The skirt 32, 32′ projects outward from the lower surface 314, 314′ of the plate 31, 31′, so as to cover the first and second edges 25, 27 and the distal end 23 of the hinge leaf 20. In manufacturing, the skirt 32, 32′ may be sized to fittingly wrap the hinge leaf 20. In this case, the fasteners 50 and the hinge leaf 20 can be protected from external water, and in turn prevented from becoming rusty. This helps to lengthen the service life of the whole hinge assembly, thus saving the money and time for maintenance and repair.

In addition, a first fastening member 24 is provided at the distal end 23 of the hinge leaf 20 and a second fastening member 321, 321′ is provided on the skirt 32, 32′ corresponding to the second end 313, 313′ of the plate 31, 31′, such that when the hinge cover 30, 30′ covers the hinge leaf 20, the first and second fastening members 24 and 321, 321′ engage with each other and hold the hinge cover 30, 30′ and the hinge leaf 20 together. In the present embodiment, the first and second fastening members 24 and 321, 321′ are a recess and a bulge, respectively.

However, in other embodiments, the plate 31, 31′ of the hinge cover 30, 30′ may work without the skirt 32, 32′. In this case, the foregoing first and second fastening members (not shown) may be provided at the distal end 23 of the hinge leaf 20 and the second end 313, 313′ of the plate 31, 31′, respectively, to engage with each other and hold the hinge cover 30, 30′ and the hinge leaf 20 together.

The first and second fastening members 24 and 321, 321′ serve to make the hinge cover 30, 30′ and the hinge leaf 20 combine stably without the risk of horizontal displacement.

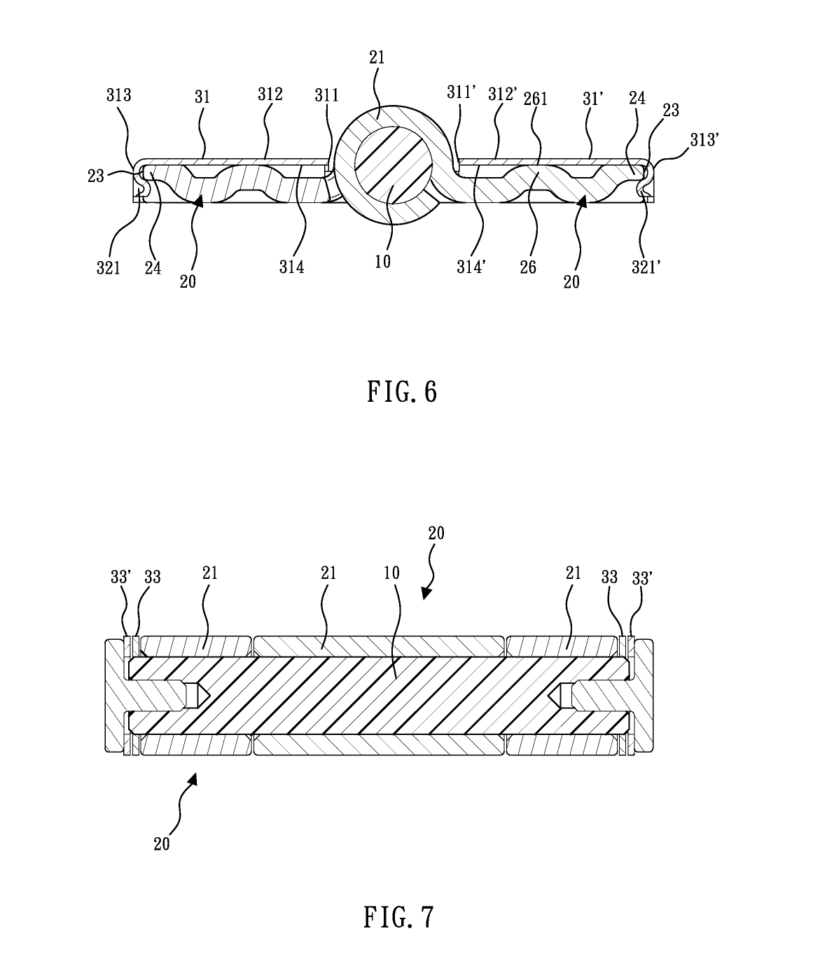

In the preferred embodiment, the hinge leaf 20 is centrally provided with a raised portion 26 such that when the hinge cover 30, 30′ covers the hinge leaf 20, a top surface 261 of the raised portion 26 fittingly contacts the lower surface 314, 314′ of the plate 31, 31′ of the hinge cover 30, 30′ and thereby props up the plate 31, 31′ from below, as shown in FIG. 6. With the raised portion 26, the hinge cover 30, 30′ and the hinge leaf 20 can combine even more stably without the risk of vertical displacement of the hinge cover 30, 30′. Meanwhile, the well supported plate 31, 31′ can better resist repeated stepping installed on a boat deck or better spread the external pressing force, and thus less tend to be deformed under long-term use.

To sum up, the present invention significantly improves the prior art by providing a covered hinge assembly that is safe and convenient in use and economical in maintenance With its unique configuration, the disclosed covered hinge assembly is perfect for marine applications, such as the installation on a boat deck, where the hinge assembly tends to contact water and receive stepping, kicking or other external impacts.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A covered hinge assembly, comprising
a pivotal pin;
at least one hinge leaf, extending between a proximal end adjacent the pivotal pin and a distal end, the hinge leaf extending between opposite first and second edges, the hinge leaf having at least one fastener penetrating therethrough, the fastener having a head; and
at least one hinge cover, including:
a plate extending between opposite first and second ends, the plate extending between opposite first and second edges, the plate having opposite upper and lower surfaces, the plate covering the hinge leaf and the fastener head; and
a connecting portion being provided at the first end of the plate, the connecting portion rotatably combining with the pivotal pin so as to pivot, together with the plate, on the pivotal pin.

2. The covered hinge assembly of claim 1, wherein the first end of the plate of the hinge cover is juxtaposed with the proximal end of the hinge leaf, and the second end of the plate of the hinge cover is juxtaposed with the distal end of the hinge leaf.

3. The covered hinge assembly of claim 1, wherein the first and second edges of the plate of the hinge cover are juxtaposed with the first and second edges of the hinge leaf, respectively.

4. The covered hinge assembly of claim 1, wherein the hinge leaf is provided with at least one raised portion such that when the hinge cover covers the hinge leaf, a top surface of the raised portion fittingly contacts the lower surface of the plate of the hinge cover and thereby props up the plate from below.

5. The covered hinge assembly of claim 1, wherein the connecting portion is at least one ring or hook integratedly formed at the first end of the plate to be mounted around the pivotal pin.

6. The covered hinge assembly of claim 1, wherein the hinge cover is made of stainless steel or plastic.

7. The covered hinge assembly of claim 1, wherein the plate of the hinge cover has a skirt extending along the first and second edges and the second end of the plate, the skirt projecting outward from the lower surface of the plate, so as to cover the first and second edges and the distal end of the hinge leaf.

8. The covered hinge assembly of claim 7, wherein a first fastening member is provided at the distal end of the hinge leaf and a second fastening member is provided on the skirt corresponding to the second end of the plate, such that when the hinge cover covers the hinge leaf, the first and second fastening members engage with each other and hold the hinge cover and the hinge leaf together.

9. The covered hinge assembly of claim 7, wherein a first fastening member is provided at the distal end of the hinge leaf and a second fastening member is provided on the second end of the plate, such that when the hinge cover covers the hinge leaf, the first and second fastening members engage with each other and hold the hinge cover and the hinge leaf together.
